(19) United States
(12) Patent Application Publication
(10) Pub. No.: US 2014/0150264 A1
(43) Pub. Date: Jun. 5, 2014

(54) Razor Handle

(71) Applicant: Gregg A. Micinilio, Trumbull, CT (US)

(72) Inventor: Gregg A. Micinilio, Trumbull, CT (US)

(73) Assignee: Eveready Battery Company Inc., St. Louis, MO (US)

(21) Appl. No.: 13/705,498

(22) Filed: Dec. 5, 2012

(51) Int. Cl. B26B 21/52; B26B 21/44

(52) U.S. Cl. CPC B26B 21/52; B26B 21/443
USPC 30/41

(57) ABSTRACT

A safety razor includes a razor cartridge connected to a razor handle. When the safety razor is at rest on a horizontal surface the areas of contact of the razor handle and the horizontal surface include a surface of an opposed end of the grip portion of the handle and a surface of a foot at a first end of the grip portion. When the safety razor is in this at rest position the razor cartridge is spaced from the horizontal surface. A shaving aid body of the cartridge that can be water swellable is also spaced from the horizontal surface. By application of an external force the safety razor can be rocked to a position where the razor cartridge additionally contacts the horizontal surface. When the safety razor is released from the rocked position it self-rights to its at rest position.

### CROSS REFERENCE TO RELATED APPLICATIONS

This application claims the benefit of International Application US2011/038678, filed Jun. 1, 2011 which claims the benefit of U.S. provisional patent application serial number 61/359,482, filed Jun. 29, 2010, the content of both being incorporated herein in their entirety for reference.

### TECHNICAL FIELD

This disclosure relates generally to wet shaving devices, and more specifically to the form and structure of a razor handle for such a device.

### BACKGROUND

Many modem wet shaving razors, also known as safety razors, comprise a handle and a cartridge joined to handle. The razor may be disposable where the handle and cartridge together are disposed of after use. Alternatively, the razor may be in the form of a so-called system that comprises a longer term use handle that is reused and a removable and disposable cartridge that is disposed after use and can be replaced with a new cartridge. The cartridge includes a housing having razor blade(s) with sharpened cutting edge(s) typically disposed between a guard forward of the cutting edges and a cap aft of the cutting edges. The cartridge can be pivotal about a pivot axis with respect to the handle and a pivot mechanism can permit the cartridge to pivot about the pivot axis.

Many modern cartridges for wet shaving razors include a shaving aid body which can comprise a shaving aid material that can include a water soluble polymer such as polyethylene oxide. One suitable polyethylene oxide is manufactured by the Dow Corporation under the trade name POLYOX™. Polyethylene oxide is available in a range of molecular weights from about 100,000 to about 8 million. Higher molecular weight polyethylene oxides are preferred for wet shaving applications as these can be more lubricious when wet which is a desirable characteristic for a shaving aid body on a razor cartridge. A blend of high and low molecular weight polyethylene oxides can also be used.

After a normal wet shaving operation, typically conducted in a wet environment, many users will rest their (initially wet) safety razor on a horizontal surface such as a bathroom vanity, the rim of a bathtub or a shelf of a cabinet for storage. When rested as such, the points of contact of typical safety razors are an end portion of the handle and a wall of a housing of the razor cartridge that can, for example, be in the guard region of the cartridge, forward of the cutting edges of the razor blades. In some applications a guard of a razor cartridge can be provided with a shaving aid body. Thus, in some situations a wetted shaving aid containing portion of a razor cartridge can be rested on or close to a horizontal surface. If the shaving aid body of the rested razor is on or close to the horizontal surface, a film of water can be retained between the shaving aid body and the horizontal surface due to e.g. surface tension effects of the water. This can be exaggerated if the horizontal surface is also wet and/or if the initially wet razor drains by gravity at least partially through the e.g. guard region of the cartridge. This retained film of water increases the wet exposure time of the shaving aid material of the shaving aid body beyond that of the duration of a normal shaving operation and can prematurely deplete a water soluble shaving aid material from the shaving aid body. Extended exposure to water can also soften the shaving aid material, for example if the shaving aid material is a soap-type material, such that its wear rate upon subsequent use is increased and thus the expected life of the shaving aid body and in turn the user-perceived life of the razor cartridge is reduced. The retained film of water between the shaving aid body and the surface will also include some dissolved water soluble shaving aid material Eventually the water portion of the retained film will evaporate, however the residual shaving aid material at the area of contact can act as weak glue, can leave an undesirable residue on the surface and can undesirably adhere the razor to the horizontal surface.

### SUMMARY

The present disclosure has for its objective to eliminate, or at least substantially alleviate the limitations of the prior art by providing a handle for a safety razor having a form and structure wherein an attached razor cartridge is spaced away from any horizontal surface the razor can be rested upon after use. Retention of any film of water between the razor cartridge and thus any shaving aid body of the razor cartridge and the horizontal surface is avoided. The safety razor comprises a razor cartridge having a housing with an upper surface and a shaving aid body including a water soluble shaving aid material connected to a razor handle. The razor handle has a head portion having razor cartridge connecting structure, and a grip portion including an opposed end with a first external surface and a first end including a foot having a terminating surface. When the safety razor is in an at rest position on a generally horizontal surface, areas of contact of the safety razor to the horizontal surface include the first external surface and the terminating surface of the foot and furthermore the razor cartridge is spaced from the horizontal surface.

The safety razor can be rocked away from the at rest position on the horizontal surface by application of an external force (e.g. by a user's digit) to a rocked position. In the rocked position the areas of contact of the safety razor to the horizontal surface include an edge portion of the first external surface, an edge portion of the terminating surface of the foot and the upper surface of the razor cartridge. The safety razor defines a center line and a center of mass. When the safety razor is in the rocked position the center of mass is within a region normal to the horizontal surface and bounded at opposed sides by the centerline of the razor in the at rest position and lines connecting sequentially the edge portion of the first external surface, the edge portion of the terminating surface of the foot and the upper surface of the razor cartridge. In this way the safety razor will self-right to its at rest position when released from its rocked position.

These and other features and advantages of the present disclosure will be more fully understood with reference to the following detailed description when taken in conjunction with the accompanying drawings.

### BRIEF DESCRIPTION OF THE DRAWINGS

FIG. 1 is a plan view of an embodiment of a safety razor in an at-rest position.

FIG. 2 is a side view of FIG. 1.

FIG. 3 is a front view of a safety razor of FIG. 1.

FIG. 4 is a plan view of an embodiment of a safety razor in a rocked position.

FIG. 5 is a side view of FIG. 4.

FIG. 6 is a front view of FIG. 4.

FIG. 6A is an enlarged portion of another embodiment of FIG. 6.

### DETAILED DESCRIPTION

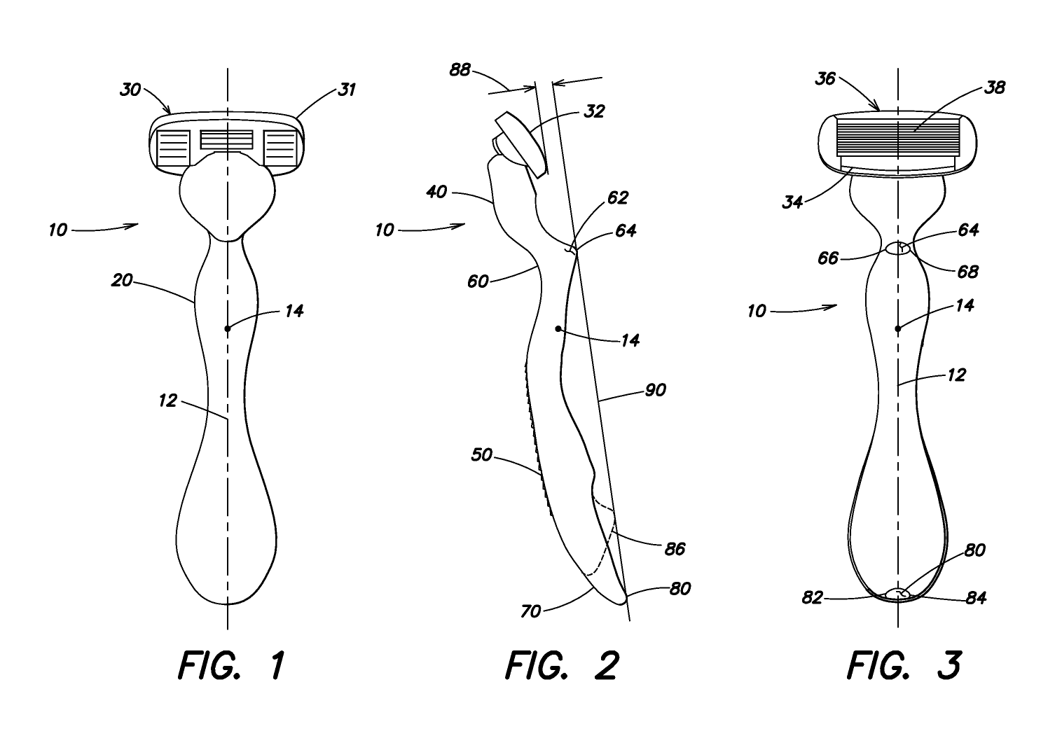

Referring now to the drawings and in particular FIGS. 1-3 a safety razor 10 is depicted. The safety razor comprises a razor handle 20 and, connected thereto, a razor cartridge 30. The safety razor 10 defines a center line 12 and a center of mass 14. The razor cartridge includes a housing 31 having an upper surface 32 and a guard 34 and cap 36 disposed respectively forward and aft of razor blades 38 mounted in the housing. One or both the guard and cap can be provided with a shaving aid body including a water soluble shaving aid material Some shaving aid bodies can be formed (e.g. extruded) to provide a water soluble polymer in a matrix of a water insoluble polymer. Other shaving aid bodies can comprise a compacted water soluble polymer within a perforated shell or sheath.

Typical water soluble polymers include polyethylene oxide, polyvinyl pyrrolidone, polyacrylamide, modified hydroxyalkyl cellulose, polyvinyl imidazoline, polyvinyl alcohol, polysulfone and polyhydroxyethylmethacrylate. A preferred lubricious water-soluble polymer is polyethylene oxide. The more preferred polyethylene oxides generally are known as POLYOX (available from Dow Corporation) or ALKOX (available from Meisei Chemical Works, Kyoto, Japan). These polyethylene oxides will preferably have molecular weights (MW) of about 100,000 to 8 million. It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g. POLYOX COAGULANT) and about 60% to 20% of polyethylene oxide having an average molecular weight of about 300,000 (e.g. POLYOX WSR-N-750). A 60:40 blend of these two polyethylene oxides (5 million: 300,000) can be especially preferred.

The water soluble shaving aid material can also include a soap-type material, e.g. a synthetic detergent or a saponified material. The water soluble shaving aid material can also include materials that swell when wetted. Some examples of water swellable shaving aid materials are disclosed in U.S. Pat. No. 5,626,154 to Rogers et al. incorporated herein for reference for its disclosure of such materials. Other water swellable shaving aid materials include polyethylene oxide particularly with a relatively high molecular weight POLYOX COAGULANT) if this material is e.g. provided in a compacted form in a perforated shell.

The razor handle includes a head portion 40 including razor cartridge connecting structure (not identified), this structure preferably provides connection to the razor cartridge such that a user may selectively replace the razor cartridge when he or she finds this appropriate. Alternatively, the safety razor may be disposable where the razor handle and razor cartridge together are disposed of after use. The handle also includes a grip portion 50 having a first end 60 adjacent the head portion 40, and an opposed end 70. The grip portion includes a first external surface 80 having laterally opposed edge portions 82, 84. Preferably the first external surface is located close to the opposed end of the grip. The first external surface can alternatively be located away from the opposed end of the grip as indicated by dashed lines 86. The first end 60 includes a foot 62 having a terminating surface 64 with laterally opposed edge portions 66, 68. Referring in particular to FIG. 2, when the safety razor is in an at rest position on a generally horizontal surface depicted as 90, for example upon which the razor can be stored between periods of use, areas of contact of the safety razor to the horizontal surface include the first external surface 80 and the terminating surface 64 of the foot. The razor cartridge is spaced from the horizontal surface 80 preferably by a distance 88 at least 1 mm, more preferably at least 3 mm and most preferably at least 5 mm. The higher value spacing distances are more preferred as some shaving aid materials can swell when wetted which can effectively reduce this spacing for a wet safety razor compared to a dry safety razor.

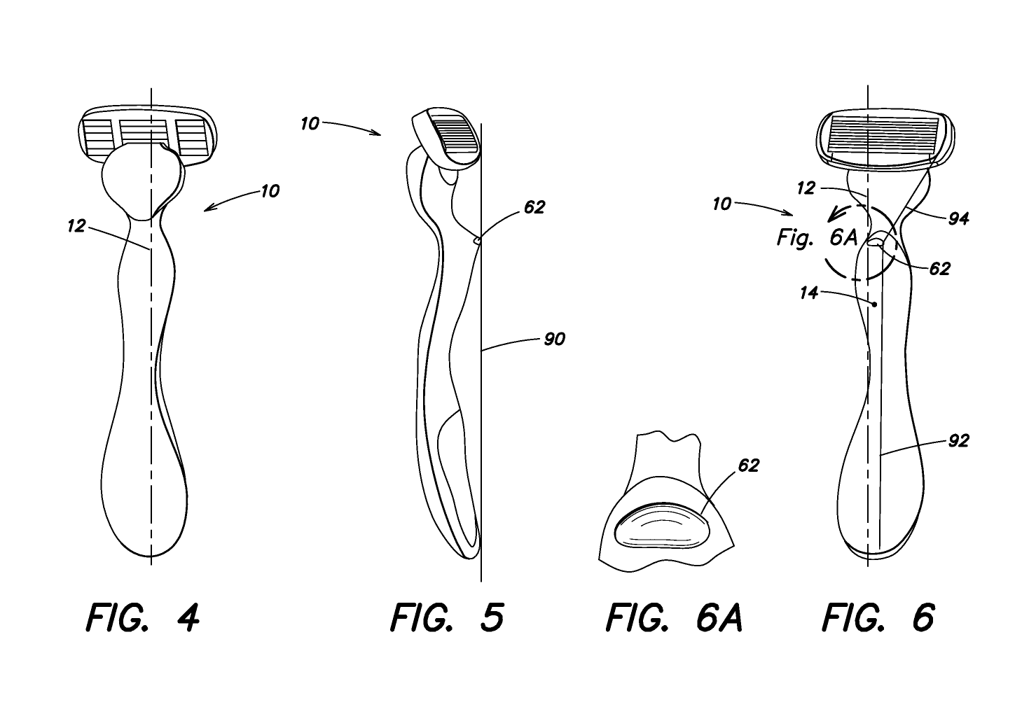

By application of an external force, e.g. by a user's digit, the safety razor on the horizontal surface can be rocked away from the at rest position by to a rocked position, as depicted in FIGS. 4-6. In the rocked position the areas of contact of the safety razor to the horizontal surface include an edge portion (82 or 84) of the first external surface, an edge portion (66 or 68) of the terminating surface of the foot and the upper surface 32 of the razor cartridge. The centerline of the razor in its at rest position is identified as 12. Wherein, when the safety razor is in the rocked position the center of mass 14 is within a region normal to the horizontal surface 90 and bounded at opposed sides by the centerline of the razor in the at rest position 12 and hypothetical lines connecting sequentially the edge portion of the first external surface and the edge portion of the terminating surface of the foot 92 and the edge portion of the terminating surface of the foot and the upper surface of the razor cartridge 94.

In this way the safety razor will self-right to its at rest position when released from its rocked position.

Preferably one or both the terminating surface of the foot or the first external surface include a flat or concave region (see FIG. 6A). When the safety razor is released from a rocked position it will tend to not excessively oscillate about the at rest position before it becomes stationary in the at rest position. As used herein the term concave is intended to not be limited to a continuously smoothly curved surface but to include any recessed surface.

The razor handle of the safety razor has form and structure such that a retained film of water between a shaving aid material containing element of the razor cartridge and a generally horizontal resting surface the razor can be stored upon between periods of use can be prevented. If the safety razor is disturbed from its at rest position to a rocked position by application of an external force the safety razor will self-right to its at rest position. If the safety razor were to maintain the rocked position a portion of the razor cartridge housing will be in contact with the resting surface and provide an opportunity for an undesirable retained film in the vicinity of the point of contact of the razor cartridge housing to the resting surface that can be caused by e.g. surface tension effects.

Although the disclosure has been described and illustrated with reference to specific illustrative embodiments thereof, it is not intended that the disclosure be limited to those illustrative embodiments. Those skilled in the art will recognize that variations and modifications can be made without departing from the true scope of the disclosure as defined by the claims that follow. For instance, features disclosed in connection with any one embodiment can be used alone or in combination with each feature of the respective other embodiments.

What is claimed is:

1. A safety razor, comprising:
a razor cartridge comprising a housing having an upper surface and razor handle connecting structure; and a shaving aid body including a water soluble shaving aid material;
a razor handle having a head portion including razor cartridge connecting structure and a grip portion including a first end including a foot having a terminating surface and an opposed end having a first external surface;
wherein, when the safety razor is in an at rest position on a generally horizontal surface, areas of contact of the safety razor to the horizontal surface include the first external surface and the terminating surface of the foot and wherein the razor cartridge is spaced from the horizontal surface.

2. The safety razor of claim 1, wherein the safety razor on the horizontal surface can be rocked away from the at rest position by application of an external force to a rocked position, wherein in the rocked position the areas of contact of the safety razor to the horizontal surface include an edge portion of the first external surface, an edge portion of the terminating surface of the foot and the upper surface of the razor cartridge;
wherein the safety razor defines a center line and a center of mass and wherein, when the safety razor is in the rocked position the center of mass is within a region normal to the horizontal surface and bounded at opposed sides by the centerline of the razor defined in the at rest position and lines connecting sequentially the edge portion of the first external surface, the edge portion of the terminating surface of the foot and the upper surface of the razor cartridge such that the safety razor will self-right to its at rest position when released from its rocked position.

3. The safety razor of claim 1, wherein the first external surface is located close to an extreme end of the opposed end of the grip portion.

4. The safety razor of claim 1, wherein the terminating surface of the foot is substantially flat.

5. The safety razor of claim 1, wherein the terminating surface of the foot is concave.

6. The safety razor of claim 1, wherein shaving aid material swells upon contact with water.

7. The safety razor of claim 1, wherein a shaving aid of the razor cartridge is spaced at least 1 mm from the horizontal surface.

8. The safety razor of claim 7, wherein a shaving aid of the razor cartridge is spaced at least 3 mm from the horizontal surface.

9. The safety razor of claim 7, wherein a shaving aid of the razor cartridge is spaced at least 5 mm from the horizontal surface.

10. The safety razor of claim 1, wherein the spacing of the razor cartridge from the horizontal surface prevents the formation of a retained film of water between the shaving aid body of the razor cartridge and the horizontal surface.
